(19) United States
(12) Patent Application Publication
(10) Pub. No.: US 2005/0195556 A1
(43) Pub. Date: Sep. 8, 2005

(54) Method of building multi-layer ceramic chip (MLCC) capacitors

(76) Inventor: Rajendra R. Shah, Marlton, NJ (US)

Correspondence Address: RAJENDRA R. SHAH, 9 GRANVILLE COURT, MARLTON, NJ, 08053, US

(21) Appl. No.: 11/073,082

(22) Filed: Mar. 5, 2005

Related U.S. Application Data
(60) Provisional application No. 60/551,073, filed on Mar. 8, 2004.

(51) Int. Cl. H01G 4/06

(52) U.S. Cl. 361/321.5

(57) ABSTRACT

This invention describes here the alternate method of building multi-layer ceramic chip capacitors, known as MLCC capacitors. A method of building alternate layers of ceramic (dielectric) and metal conductive electrodes (FIG. 2) by using screen printer and screen-printing process. This invention suggests using only screen printers and screen printing process (no tape casting) to build MLCC capacitors. In the current MLCC capacitors manufacturing process, ceramic dielectric layer is formed by tape casting process and metal electrode layer is formed by screen printing (FIG. 1) process. In this invention, entire multi-layer structure consisting of ceramic dielectric layers and metal electrode layers are formed by screen printing process. In other words, using screen printer, screen-print ceramic dielectric layers on a substrate to the required thickness, with drying in between the layers. Next, on top of the dielectric layer, screen print electrode pattern and dry it. This sequence is repeated and all alternate dielectric layer and electrode pattern are formed by screen printing process until the stack contain desired numbers of ceramic dielectric layers and metal electrode layers.

### DESCRIPTION OF THE PRIOR ART (PROCESS)

For many years to present day, most common process and art of manufacturing MLCC capacitors and other multi-layer ceramic structures (LTCC, HTCC, Actuators, Thermistors and SOFC) is done by combined process of tape casting and screen-printing. In the tape casting method, minute ceramic particles with organic binders are mixed with water or organic solvents to prepare homogeneous ceramic slurry. This ceramic slurry is spread thinly on a carrier tape or belt by doctor blade method and dried and formed into ceramic sheet. These sheets are blanked into desired size and printed with conductive paste on one side of the sheet by screen printing process and dried, there by forming electrodes pattern on the ceramic sheet. Conductive paste or also know as ink is made out of desired minute metal particles mixed with organic vehicle and blended in a three roll mill to make homogeneous paste of required viscosity suitable for screen printing process. Next, each such ceramic sheet with electrodes pattern on it are stacked and or laminated, compressed, diced and sintered or co-fired to get individual chip capacitor. Similar process is used to build other ceramic multi-layer structures. For e.g. LTCC, HTCC, SOFC, etc.

Another process and art of manufacturing MLCC capacitors but less common then the above tape casting process is by ‘Ceramic Curtain Process’. In this process a substrate with index holes (alignment purpose) with porous paper covered layer is passed through a curtain of falling ceramic slurry. This forms a thin coating of ceramic layer on the substrate. The ceramic layer is dried and substrate is again passed through the curtain of falling ceramic slurry until the required thickness of the ceramic layer is formed. The ceramic slurry is prepared with minute ceramic particles mixed with binders and organic solvent to desired slurry viscosity suitable for the ‘Curtain Process’. Next, the substrate is mounted on the screen printer with index holes in the proper position and a pattern of metal electrode is screen printed on top of the ceramic dielectric layer and dried. This sequence is repeated and multi-layer structure of alternate dielectric and electrode is formed until the stack contains the desired number of active ceramic dielectric layers and metal electrode layers to build a multi-layer structure. Next, this substrate carrying the complete stack (cake) is mounted on a table and diced and sintered to form individual MLCC capacitors.

### GENERAL DESCRIPTION OF MLCC CAPACITOR

Structure of MLCC capacitors consists of multi-layers of plate capacitors placed parallel to each other in a ceramic chip form. In other words, alternate many layers of metal-dielectric-metal placed parallel to each other in a chip form. By definition, capacitance is proportional to dielectric constant, area of electrodes, number of parallel electrodes and inversely proportional to dielectric thickness. In recent years, MLCC capacitor manufacturers are looking for ways to build smaller and smaller components and with higher capacitance values. In short, looking for ways to get higher c/v ratio in a capacitor. I.e. High capacitance value in a smaller volume of component. From above equation, effective ways to get higher c/v ration would be either by using dielectric material with higher dielectric constant and/or using thinner dielectric ceramic tape while keeping the same number of electrodes. As described above, thinner the dielectric ceramic tape (dielectric thickness), higher the capacitance value. There has been much technological advancement in the recent years in the tape casting process itself and in the materials and ceramic slurry preparation process. But, it is a fact that as the ceramic tape thickness is reduced to microns level there is an increase in a degree of difficulty in handling and processing further of these thin tapes in manufacturing of MLCC capacitors.

### DESCRIPTION OF THE INVENTION (NEW PROCESS)

To overcome above problem, this paper suggests using screen printer and screen printing process to build and effectively manufacture multi-layer ceramic chip capacitors with thin dielectric thickness (couple of microns to couple of mils in range) and thin electrode thickness (couple of microns to few microns). Screen-printing is a very matured and the most versatile of all processes in electronic components and hybrid circuit manufacturing industries. As the name suggests, it is a process to print patterns of metal, ceramic, glass or epoxy components on a wide variety of substrates, including plastic, Teflon, glass, metals, ceramic, and many other materials. Also, know as thick film process or thick film metallization by screen printing process. Screen-printing consists of three elements: the screen which is the image carrier; the squeegee; and ink (metal, cermets, ceramic and epoxy paste). The screen printing process uses a porous mesh stretched tightly over a frame made of metal. Screen printing ink is applied to the substrate by placing the screen over the substrate. Ink with a paint-like consistency is placed onto the top of the screen. Ink is then forced through the fine mesh openings using a squeegee that is drawn across the screen, applying pressure thereby forcing the ink through the open areas of the screen. Ink will pass through only in areas where no stencil is applied, thus forming an image (print) on the substrate. In electronic industries, this process is used for screen printing or in other words laying down thin layer of metal paste (ink) using a metal or plastic screen. This process is also used in laying down thin layer of other components like resistor paste, inductors paste, dielectric paste and also epoxies on substrates. The equipment used for screen printing process is known as a ‘Screen-Printer’.

The process of building entire MLCC capacitor component, by screen printing process (no tape casting or curtain process involved) is described here. The processing steps and sequence would be almost similar to the “Curtain Process’ as described earlier

Except, as the name suggests, in the curtain process, dielectric (ceramic) layer is formed by passing the substrate under the curtain of the ceramic slurry, where as in the screen printing process, as the name suggests, dielectric (ceramic) layer is formed by the screen printing process. Dielectric paste is formulated with desired ceramic components, binder and solvent. This dielectric ink or paste will have almost similar consistency to more commonly used metal paste or ink for electrodes in screen-printing. To screen print microns level of dielectric or metal layers, ink will be modified and formulated using sub micron level of respective particles.

Screen printer with flat bed or flat tool plate (to hold substrate) is most widely used in the electronic industries. A flat substrate with index holes or pins for registration purposes could be used. This substrate could be covered with porous paper or other material for easy removal of complete stack (cake) from the substrate. Substrate and material used to cover the substrate should be such that it could survive dielectric and metal paste drying temperature (150° C. to 200° C.). To build multi-layer ceramic chip capacitors, screen-print as many required layers of dielectric on top of the substrate. Dry the dielectric layer in the oven after each screen-printed dielectric layer. Place the substrate back on the screen printer and mount it on the plate with the index holes or pins in the proper places. Screen-print a layer of electrode pattern right on top of the dried dielectric layer. Dry the electrode layer in the oven as before. Continue this sequence of alternate layers of dielectric and electrode layer as per the design to build multi-layer structure.

For better electrode alignment and to make the process more practical, use one screen printer to screen print a dielectric layers and another screen printer to screen print electrode patterns. To make a process still more practical a third screen printer could be used to screen print a layer of electrode which is little offset to the previous electrode in building of MLCC capacitors. Once the multi-layers are build up as per the design, remove the substrate from the plate and place it on the table and dice the ceramic block (cake) into individual chip components. Sinter these chips (co-fire) at the required temperature to form MLCC capacitors.

The rate of screen printing process was once dictated by the drying rate of the screen print inks. But, due to recent improvements and innovations in screen printers and in the screen printing materials, manufacturing of MLCC capacitors by this process would be cheaper then to manufacture by tape casting process. Some specific innovations that have also increased screen-printing popularity include:
Development of state of the art automatic screen printers that gives more uniform material lay down thickness and accurate electrode registration and alignment.
Improved drying systems that significantly improve production rate.
Development and improvement of ink formulation technologies.
Development of the rotary screen printer that allows continuous operation of the screen printer.
Ability to screen-print larger area that could build larger multi-layer ceramic block. Ceramic block by screen printing process could be built much larger then built by current tape casting process. This will give several times more individual chip components then possible by tape casting, laminated and pressed process.

The most advantage in building capacitors by this invention process is that screen printing allows one to get controlled dielectric thickness from micron levels (couple of microns) to mils level instead of in mils or some fraction of mils in standard process of tape casting. The dielectric paste used for screen print thin dielectric layer will contain very fine ceramic particles (nano particles) of desired composition and will be formulated to rheological properties suitable especially for screen printing purpose. Metal paste will also be made out of very fine metal particles (nano particles) and will be formulated to rheological properties suitable especially to get very thin layers (couple of microns) of metal electrode thickness.

### DESCRIPTION OF THE DRAWING

FIG. 1 shows the cross section of a typical MLCC capacitors build by tape casting process. Where as shown, dielectric ceramic layer is formed by tape casting process and on top of it, metal electrode layer is formed by screen printing process.

FIG. 2 shows cross section of the MLCC capacitor that could be built by new invention process, where entire multilayer structure of alternate dielectric ceramic and metal electrode layers formed by screen printing process.

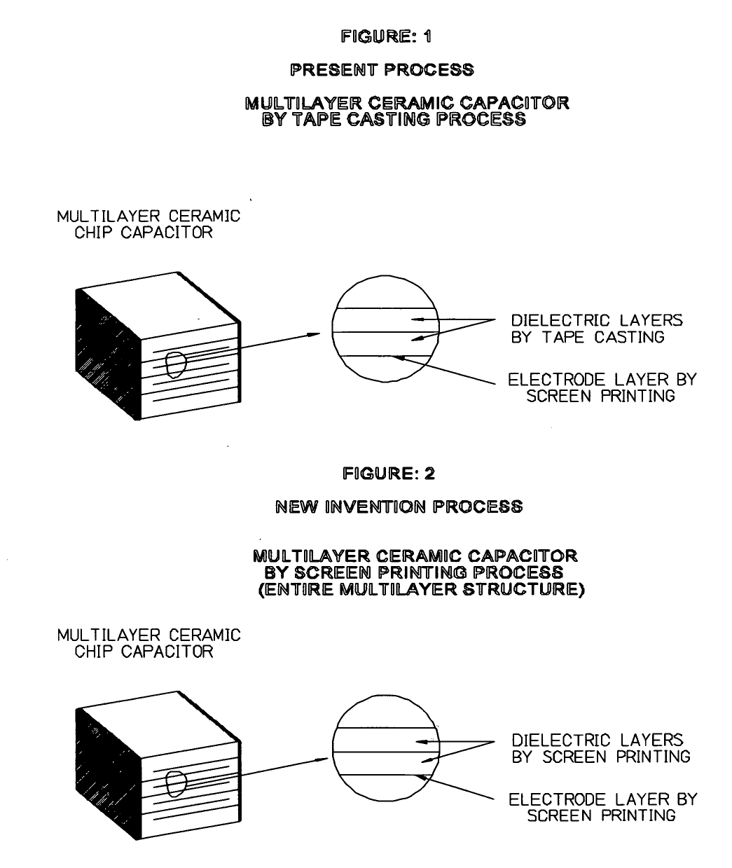

1. MLCC capacitors with thin dielectric thickness (2-3 microns or more) are possible to manufacture by new process as described in this invention.

2. MLCC capacitors with thin dielectric thickness as described in a claim 1 are easier to manufacture by new process as described in this invention then when manufactured by the current process of tape casting.

3. MLCC capacitor size could be reduced by manufacturing with the new invention to get same capacitance value when manufactured by the current process of tape casting.

4. Ability to screen-print larger area is advantageous to build larger multi-layer ceramic block (described in this invention) then the ceramic block built by tape casting process.

5. Larger multi-layer ceramic block made by new invention as described in claim 4, produces larger number of chip components (because of more surface area) then possible by current process of tape casting.

6. Cost of manufacturing MLCC capacitors by new process as described in this invention could be much lower then when manufactured by the current process of tape casting.

7. No stacking and/or lamination of ceramic sheets are required in this invention. Alignment is done by index (reference) holes or pins on the substrate during screen printing process. In MLCC capacitors, LTCC, HTCC, SOFC and other multi-layer ceramic components, better electrode alignment (<0.003 inch) is possible from layer to layer when built entirely by screen printing process (this new invention).

8. Unlike stacking and lamination process where compression is required to form stacked structure which inevitably leads to occurrence of shear forces and possible irregular sinuous electrode pattern. No compression is required in this invention and there by minimum shear force is present in the structure this gives accurately arranged electrode pattern one upon the other.

9. Multi-layer components with better aligned through holes are also possible when entire structure is built by this new invention.
